(19) United States
(12) Patent Application Publication
(10) Pub. No.: US 2026/0365454 A1
(43) Pub. Date: Nov. 19, 2026

(54) SHOE ASSEMBLY INCLUDING RELEASABLE SHOE CAP AND CONVEYOR SORTATION SYSTEMS INCLUDING THE SAME

(71) Applicant: TREW, LLC, West Chester, OH (US)

(72) Inventors: Jeffrey L. Vessell, Morrow, OH (US); TJ Vue, Deforest, WI (US); Jerod W. Batt, Loveland, OH (US)

(73) Assignee: TREW, LLC, West Chester, OH (US)

(21) Appl. No.: 19/206,478

(22) Filed: May 13, 2025

(51) Int. Cl. B65G 47/84; B65G 17/34; B65G 47/82

(52) U.S. Cl. CPC B65G 47/844; B65G 17/345; B65G 47/82

(57) ABSTRACT

A shoe assembly includes an adapter and a cap. The adapter includes an inner hook and an outer hook. The cap includes an upper plate having a contact wall, and an inner latch and an outer latch extending from an inner surface of the upper plate. The inner latch is located at a different vertical plane than the outer latch. The inner latch of the cap engages the inner hook of the adapter and the outer latch of the cap engages the outer hook of the adapter. The inner latch and the outer latch deform to disengage the inner hook and the outer hook upon a force exceeding a predetermined threshold being imparted onto the contact wall of the cap.

### TECHNICAL FIELD

The present specification generally relates to conveyor sortation systems and, more specifically, diverter shoes for conveyor sortation systems.

### BACKGROUND

In conveyor-based sorting systems, diverter shoes are commonly used to laterally guide articles off a conveying surface of the sorting system and onto designated chutes or secondary conveyors. These shoes travel along guided tracks and are actuated to divert articles at precise moments, ensuring efficient and accurate sorting. Traditional diverter shoes are typically constructed from durable plastics or composites to withstand repeated impacts and frictional forces encountered during operation. However, conditions can occur during operation that can lead to excessive forces being applied to a cap of the diverter shoes while the diverter shoes are traveling across the sorting system while guiding articles. This can lead to damage to conveyor components, such as divert rails, guide blocks, switches, slats, and diverter shoes, as well as the articles.

To address these challenges, there is a need for an improved diverter shoe design to minimize the likelihood of damage to conveyor components.

### SUMMARY

In one embodiment, a shoe assembly including: an adapter including an inner hook and an outer hook; and a cap including an upper plate having a contact wall, and an inner latch and an outer latch extending from an inner surface of the upper plate, the inner latch located at a different vertical plane than the outer latch, wherein the inner latch of the cap engages the inner hook of the adapter and the outer latch of the cap engages the outer hook of the adapter, wherein the inner latch and the outer latch deform to disengage the inner hook and the outer hook upon a force exceeding a predetermined threshold being imparted onto the contact wall of the cap.

In another embodiment, a cap for a shoe assembly including: an upper plate including an outer surface, an inner surface opposite the outer surface, a contact wall, a side wall opposite the contact wall, a leading wall, and a trailing wall opposite the trailing wall defining an open interior; an inner latch extending from the inner surface of the upper plate, the inner latch provided entirely within the open interior; and an outer latch extending from the inner surface of the upper plate, the outer latch provided entirely within the open interior, wherein the inner latch is provided closer to the trailing wall than the outer latch, wherein the inner latch defines an inner shoulder provided at a first vertical position and the outer latch defines an outer shoulder provided at a second vertical position below the first vertical position.

In yet another embodiment, a conveyor sortation system includes: a plurality of shoe assemblies, each shoe assembly of the plurality of shoe assemblies slidably engaged with a respective slat of the plurality of slats and configured to move along a divert guide path positioned below the plurality of slats, each shoe assembly of the plurality of shoe assemblies movable along the respective slat of the plurality of slats in a translating direction perpendicular to the moving direction, each shoe assembly including: an adapter including an inner hook and an outer hook; and a cap including an upper plate having a contact wall, and an inner latch and an outer latch extending from an inner surface of the upper plate, the inner latch located at a different vertical plane than the outer latch, wherein the inner latch of the cap engages the inner hook of the adapter and the outer latch of the cap engages the outer hook of the adapter, wherein the inner latch and the outer latch deform to disengage the inner hook and the outer hook upon a force exceeding a predetermined threshold being imparted onto the contact wall of the cap.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a conveyor sortation system including a plurality of shoe assemblies, according to one or more embodiments shown and described herein;

FIG. 2 schematically depicts a front side perspective view of a shoe assembly of the conveyor sortation system including an adapter and a cap, according to one or more embodiments shown and described herein;

FIG. 3 schematically depicts a rear side perspective view of the adapter, according to one or more embodiments shown and described herein;

FIG. 4 schematically depicts a front side perspective view of the adapter, according to one or more embodiments shown and described herein;

FIG. 5 schematically depicts a cross-sectional view of the adapter along line 5-5 of FIG. 3, according to one or more embodiments shown and described herein;

FIG. 6 schematically depicts a front side perspective view of the cap, according to one or more embodiments shown and described herein;

FIG. 7 schematically depicts a bottom perspective view of the cap, according to one or more embodiments shown and described herein;

FIG. 8 schematically depicts a cross-sectional view of the cap taken along line 8-8 of FIG. 6, according to one or more embodiments shown and described herein;

FIG. 9 schematically depicts a cross-sectional view of the shoe assembly taken along line 9-9 of FIG. 2, according to one or more embodiments shown and described herein; and

FIG. 10 schematically depicts a flowchart of a method for operating the conveyor sortation system of FIG. 1, according to one or more embodiments shown and described herein.

### DETAILED DESCRIPTION

Embodiments described herein are directed to a shoe assembly for a conveyor sortation system including a removable and replaceable shoe cap.

The shoe assembly includes an adapter and a cap. The adapter includes an inner hook and an outer hook. The cap includes an upper plate having a contact wall, and an inner latch and an outer latch extending from an inner surface of the upper plate. The inner latch is located at a different vertical plane than the outer latch. The inner latch of the cap engages the inner hook of the adapter and the outer latch of the cap engages the outer hook of the adapter. The inner latch and the outer latch deform to disengage the inner hook and the outer hook upon a force exceeding a predetermined threshold being imparted onto the contact wall of the cap. Various embodiments of the shoe assembly and the operation of the shoe assembly are described in more detail herein. Whenever possible, the same reference numerals will be used throughout the drawings to refer to the same or like parts.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Directional terms as used herein - for example up, down, right, left, front, back, top, bottom - are made only with reference to the figures as drawn and are not intended to imply absolute orientation.

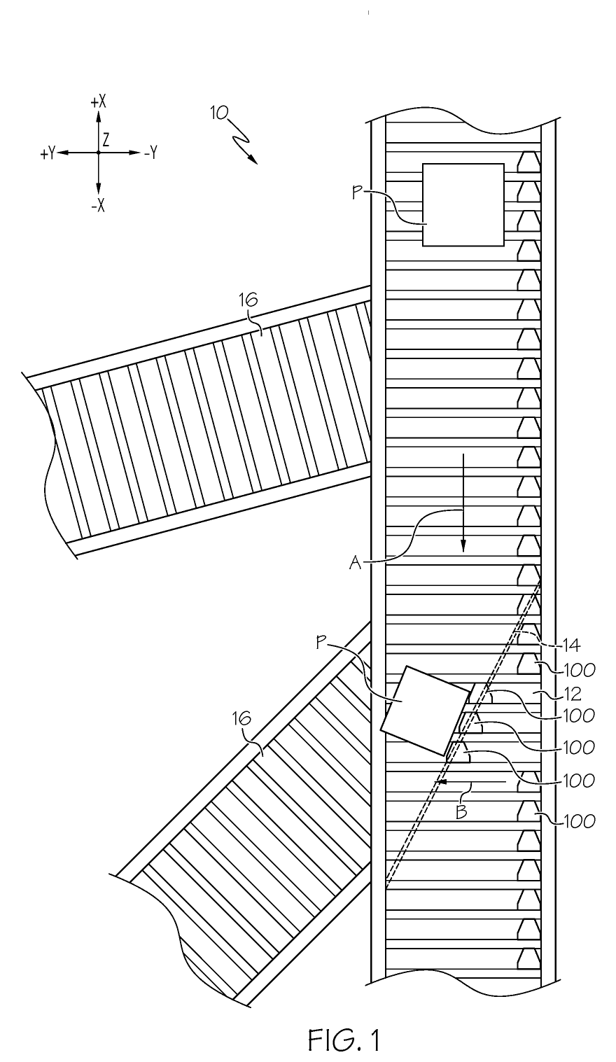

As used herein, the term “longitudinal direction” refers to the forward-rearward direction (i.e., in the +/- X direction of the coordinate axes depicted in FIG. 1). The term “lateral direction” refers to the cross direction (i.e., in the +/- Y direction of the coordinate axes depicted in FIG. 1), and is transverse to the longitudinal direction. The term “vertical direction” refers to the upward-downward direction (i.e., in the +/- Z direction of the coordinate axes depicted in FIG. 1). As used herein, “upper” and “above” are defined as the positive Z direction of the coordinate axes shown in the drawings. “Lower” and “below” are defined as the negative Z direction of the coordinate axes shown in the drawings.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Referring now to FIG. 1, a conveyor sortation system 10 is depicted. The conveyor sortation system 10 includes a plurality of slats 12 defining a conveying surface moving in a moving direction A and a plurality of the shoe assemblies 100. The plurality of shoe assemblies 100 are slidably engaged with respective slats 12 and configured to move along a divert guide path 14 positioned below the slats 12 when an actuator permits the shoe assemblies 100 to depart from a home position. At times, articles A positioned on the slats 12 may need to be diverted off of the slats 12 onto designated chutes or secondary conveyors 16. Thus, the shoe assemblies 100 are translated in a lateral direction B along the divert guide path 14 to direct the particular article or articles P off the slats 12. The lateral direction B is perpendicular to the moving direction A.

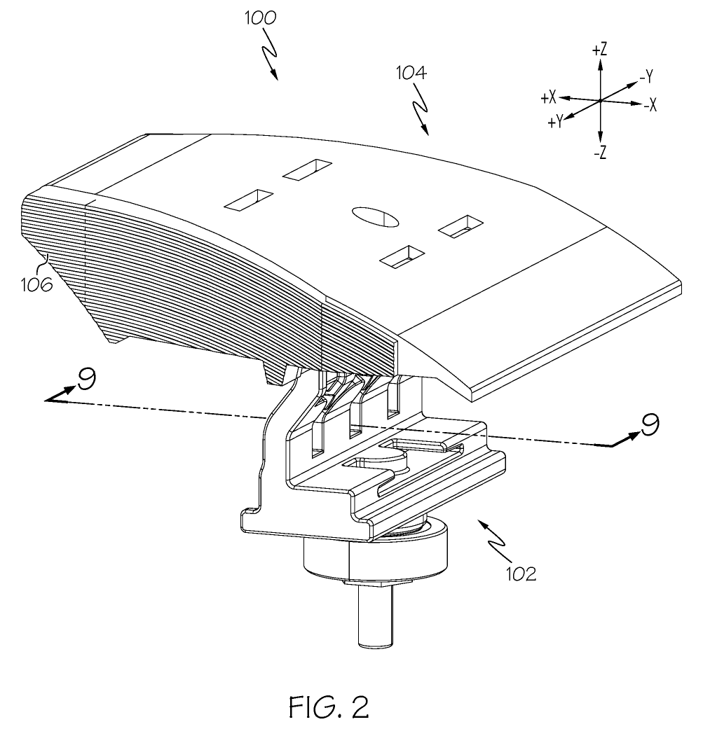

Referring now to FIG. 2, a shoe assembly 100 is illustrated according to one or more embodiments described herein. The shoe assembly 100 generally includes an adapter 102 and a cap 104 coupled to the adapter 102. The cap 104, which is mounted to the adapter 102, contacts the article or articles P being diverted off the slats 12 (FIG. 1).

As described in more detail herein, the cap 104 is released upon a force exceeding a predetermined threshold being imparted onto a contact wall 106 of the cap 104. In embodiments, the predetermined threshold is 50 pounds (lbs). In embodiments, the predetermined threshold is 75 lbs. In embodiments, the predetermined threshold is 100 lbs. In embodiments, the predetermined threshold is 125 lbs. Permitting the cap 104 to be released from the adapter upon an excessive force being applied onto the contact wall 106 of the cap 104 protects the adapter 102, the divert guide path 14, and other internal components of the conveyor sortation system 10 (FIG. 1) from damage. Additionally, this allows for the cap 104 of the shoe assembly 100 to be replaced without having to also replace the adapter 102 nor remove the adapter 102 during repair.

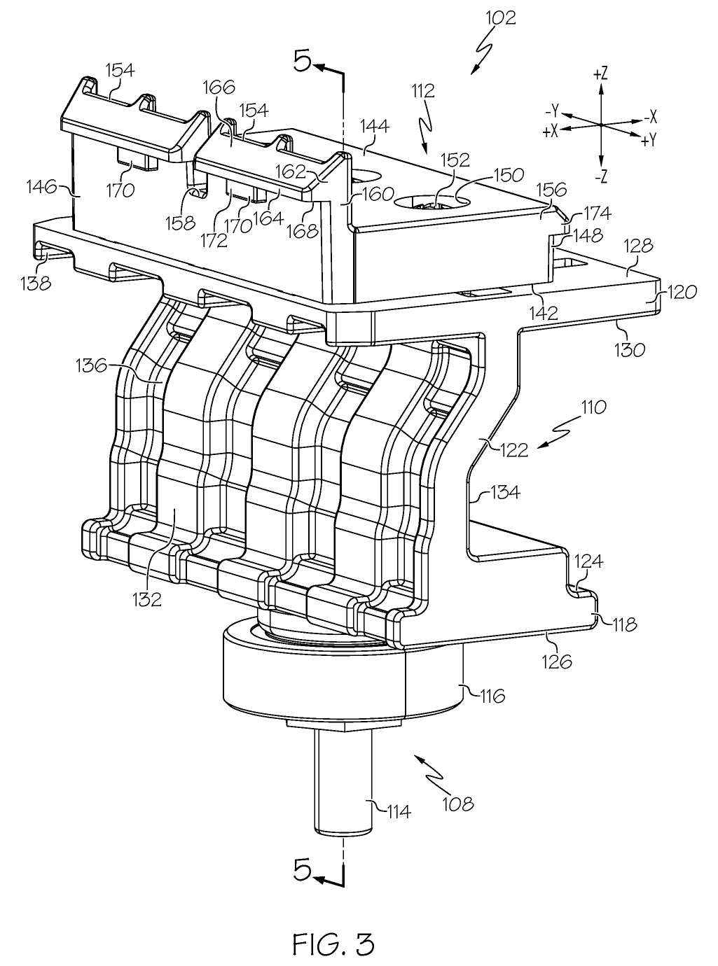

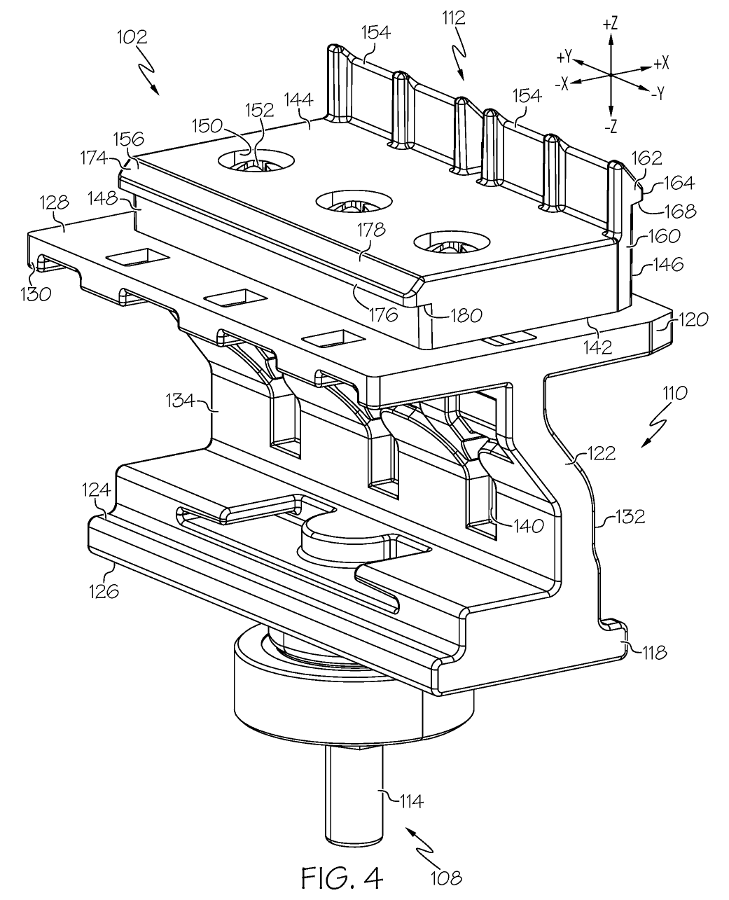

Referring now to FIGS. 3 and 4, the adapter 102 is depicted apart from the cap 104 (FIG. 2). The adapter 102 includes a base 108, a body 110, and a coupling 112. In embodiments, the adapter 102 is formed from any suitable material such as plastic, metal, rubber, synthetic polymer, thermoplastic polymer, a combination thereof, or the like. In embodiments, the adapter 102 is formed from Acrylonitrile Butadiene Styrene (ABS). The adapter 102 may be formed in any suitable manner such as by plastic injection molding, CNC machining, extrusion, 3D printing, compression molding, casting, and the like.

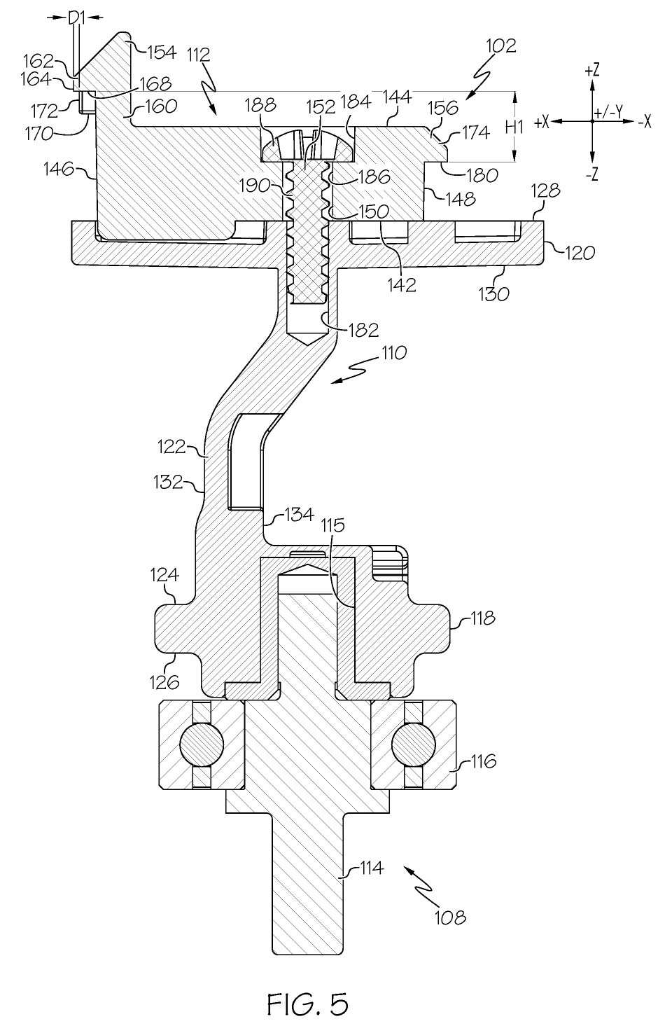

The base 108 includes a shaft 114 and a bearing 116 surrounding the shaft 114. The shaft 114 and the bearing 116 are utilized to attach the base 108, and thus the adapter 102, to the slats 12 of the conveyor sortation system 10 (FIG. 1). The shaft 114 extends partially through a channel 115 formed in the body 110, as shown in FIG. 5, and engages the body 110 to secure the base 108 to the body 110.

The body 110 includes a lower wall 118, an upper wall 120 opposite the lower wall 118, and a flange 122 extending between the lower wall 118 and the upper wall 120 in the vertical direction. The lower wall 118 includes an upper surface 124 and a lower surface 126 opposite the upper surface 124. The upper wall 120 includes an upper surface 128 and a lower surface 130 opposite the upper surface 128. The flange 122 includes an inner surface 132 and an outer surface 134 opposite the inner surface 132.

As shown in FIG. 3, in embodiments, one or more inner depressions 136 are formed in the inner surface 132 of the flange 122 and extend between the lower wall 118 and the upper wall 120. As shown, a plurality of inner depressions 136 are formed in the inner surface 132 of the flange 122. The inner depressions 136 may be arranged in any suitable manner and have any suitable geometry. As shown, the inner depressions 136 are equidistantly spaced apart from one another and extend in a linear direction from the lower surface 126 of the lower wall 118 terminating prior to the lower surface 130 of the upper wall 120. In other embodiments, the inner depressions 136 extend along the lower surface 130 of the upper wall 120. As shown, a plurality of upper depressions 138 are formed on the lower surface 126 of the upper wall 120 distinct from the inner depressions 136 formed on the flange 122.

Referring to FIG. 4, one or more outer depressions 140 are formed in the outer surface 134 of the flange 122. As shown, a plurality of outer depressions 140 may be formed. Similar to the inner depressions 136 (FIG. 3) formed on the inner surface 132 of the flange 122, the plurality of outer depressions 140 may be arranged in any suitable manner and have any suitable geometry. It should be appreciated that the inner depressions 136 and the outer depressions 140, as well as any other depressions formed in the adapter 102, are utilized to reduce material costs while maintaining structural integrity.

Referring again to FIGS. 3 and 4, the coupling 112 is shown positioned at the upper surface 128 of the upper wall 120 of the body 110. The coupling 112 includes a lower surface 142, an upper surface 144 opposite the lower surface 142, an inner surface 146, and an outer surface 148 opposite the inner surface 146. In embodiments, one or more channels 150 are formed extending through the lower surface 142 and the upper surface 144 of the coupling 112, and fasteners 152 extend through respective channels 150 to secure the coupling 112 to the body 110. The fasteners 152 may be, for example, screws, rivets, bolts, or the like. In other embodiments, the coupling 112 and the body 110 may be formed as a one-piece, monolithic component such that the coupling 112 is not removably attached to the body 110.

The coupling 112 includes one or more inner hooks 154 extending from the inner surface 146 and the upper surface 144 of the coupling 112, and one or more outer hooks 156 extending from the outer surface 148 and the upper surface 144 of the coupling 112. As shown in FIG. 3, a pair of inner hooks 154 are provided and separated by a cutout 158. However, it should be appreciated that the coupling 112 may include any number of inner hooks 154.

Each inner hook 154 includes a vertical inner hook portion 160 and a horizontal inner hook portion 162. The vertical inner hook portion 160 extends in the vertical direction opposite the lower surface 142 of the coupling 112. The horizontal inner hook portion 162 extends from the vertical inner hook portion 160 in the lateral direction opposite the inner surface 146 of the coupling 112 and terminates at a distal end 164. In embodiments, an upper surface 166 of the horizontal inner hook portion 162 is tapered. The horizontal inner hook portion 162 defines an inner lip 168 between the inner surface 146 of the coupling 112 and the distal end 164. In embodiments, a protrusion 170 is formed at each inner hook 154 and includes a leading surface 172 opposite the inner surface 146 of the coupling 112. The protrusions 170 may be fixed to a respective inner lip 168 and/or the inner surface 146 of the coupling 112.

As shown in FIG. 4, a single outer hook 156 is formed at the outer surface 148 of the coupling 112 and extends an entire width of the outer surface 148 of the coupling 112. However, it should be appreciated that the coupling 112 may include any number of outer hooks 156. The outer hook 156 includes a horizontal outer hook portion 174 extending from the outer surface 148 and the upper surface 144 of the coupling 112 and terminates at a distal end 176. The horizontal outer hook portion 174 extends in a direction opposite the outer surface 148 of the coupling 112. In embodiments, an upper surface 178 of the horizontal outer hook portion 174 is tapered. The horizontal outer hook portion 174 defines an outer lip 180 between the outer surface 148 of the coupling 112 and the distal end 176.

Referring now to FIG. 5, a cross-sectional view of the adapter 102 is depicted. As shown, the fasteners 152 extend through the channels 150 formed in the coupling 112 and into respective channels 182 formed in the upper wall 120 and the flange 122 of the body 110 to secure the coupling 112 to the body 110. The channels 150 formed in the coupling 112 include an increased diameter portion 184 extending from the upper surface 144 of the coupling 112, and a reduced diameter portion 186 extending from the increased diameter portion 184 to the lower surface 142 of the coupling 112. A head 188 of the fastener 152 is received within the increased diameter portion 184 to inhibit extension of the fastener 152 through the coupling 112, and a shaft 190 of the fastener 152 extending from the head 188 extends through the channel 150 of the coupling 112 and into the respective channel 182 formed in the body 110.

Referring still to FIG. 5, with respect to the protrusions 170, a distance D1 is defined between the leading surface 172 of the protrusion 170 and the distal end 164 of the horizontal inner hook portion 162. In embodiments, the distance D1 is 0.762 mm +/- 20%. In embodiments, the distance D1 is 0.762 mm +/- 15%. In embodiments, the distance D1 is 0.762 mm +/- 10%. In embodiments, the distance D1 is 0.762 mm +/- 5%.

As described herein and as shown in FIG. 5, the inner lip 168 of each inner hook 154 is located above the outer lip 180 of the outer hook 156 by a height H1 in the vertical direction due to the inner hooks 154 extending in the vertical direction from the upper surface 144 of the coupling 112. Accordingly, the inner lips 168 and the outer lip 180 are located at different vertical planes. In other words, the inner lips 168 are provided at a vertical position vertically offset from a vertical position of the outer lip 180. In embodiments, the height H1 is 9.525 mm +/- 20%. In embodiments, the height H1 is 9.525 mm +/- 15%. In embodiments, the height H1 is 9.525 mm +/- 10%. In embodiments, the height H1 is 9.525 mm +/- 5%.

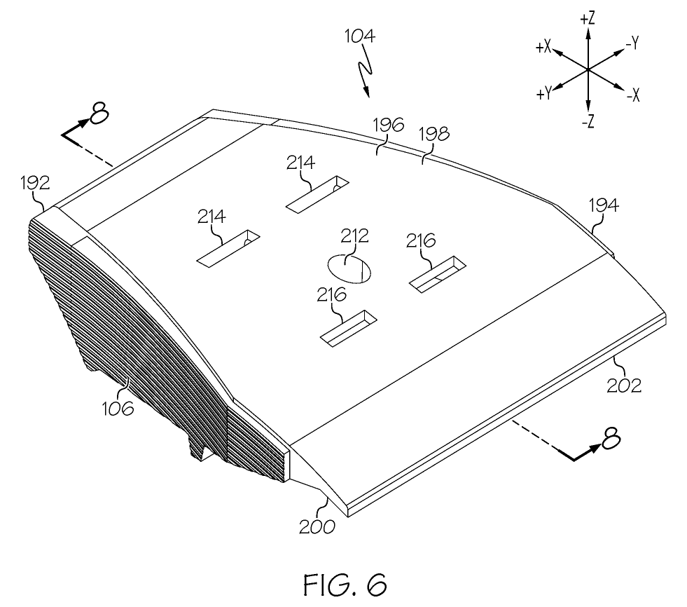

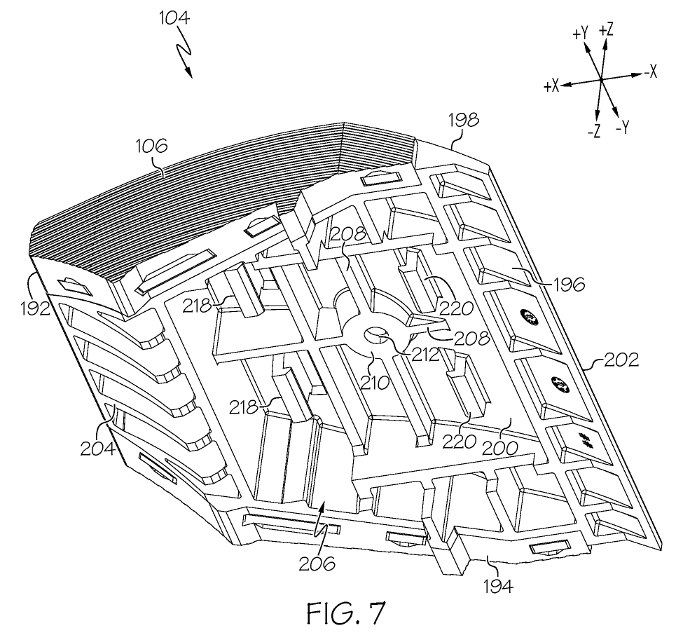

Referring now to FIGS. 6 and 7, the cap 104 is shown apart from the adapter 102 (FIG. 3). The cap 104 includes the contact wall 106, a side wall 194 opposite the contact wall 106, and an upper plate 196 extending between the contact wall 106 and the side wall 194. The upper plate 196 includes an outer surface 198, an inner surface 200 opposite the outer surface 198, a trailing wall 192, and a leading wall 202 opposite the trailing wall 192. In embodiments, the trailing wall 192 of the upper plate 196 has a width extending in the lateral direction between the contact wall 106 and the side wall 194 less than a width of the leading wall 202. As shown in FIG. 7, the trailing wall 192 has an angular portion 204 extending from the outer surface 198 of the upper plate 196 in a direction toward the leading wall 202. Accordingly, the trailing wall 192 has a height extending in the vertical direction between the outer surface 198 and the inner surface 200 greater than a height of the leading wall 202. Accordingly, in embodiments, the upper plate 196 has a curved shape.

In embodiments, the contact wall 106 and the side wall 194 are detachably coupled to the upper plate 196 in any suitable manner. In other embodiments, the contact wall 106, the side wall 194, and the upper plate 196 are formed as a one-piece, monolithic component. In embodiments, the cap 104 is formed from any suitable material such as plastic, metal, rubber, synthetic polymer, thermoplastic polymer, a combination thereof, or the like. In embodiments, the cap 104 is formed from nylon. The cap 104 may be formed in any suitable manner such as by plastic injection molding, CNC machining, extrusion, 3D printing, compression molding, casting, and the like.

Referring still to FIG. 7, the upper plate 196 defines an open interior 206 between the inner surface 200 of the upper plate 196, the contact wall 106, and the side wall 194. In embodiments, one or more ribs 208 may extend from the inner surface 200 of the upper plate 196 and between the contact wall 106 and the side wall 194 to improve structural integrity of the cap 104. In embodiments, as shown in FIG. 7, a dome 210 is formed at an intersection of a pair of ribs 208 and an aperture 212 extends through the dome 210. The aperture 212 extends through the outer surface 198 of the upper plate 196, as shown in FIG. 6. As described in more detail herein, a fastener, such as the fastener 152 (FIG. 3) may extend through the aperture 212 formed in the upper plate 196 and through a corresponding channel 150 formed in the coupling 112 of the adapter 102 to secure the cap 104 to the adapter 102. In such embodiments, the fastener, such as the fastener 152, may have a length sufficient to extend through a corresponding channel 182 of the body 110 of the adapter 102 (FIG. 5) as well.

Referring again to FIG. 6, one or more inner slots 214 and one or more outer slots 216 are formed to extend through the outer surface 198 and the inner surface 200 of the upper plate 196. As shown, a pair of inner slots 214 and a pair of outer slots 216 are formed on opposite sides of the aperture 212. It should be appreciated that the inner slots 214 and the outer slots 216 are provided to form respective inner latches 218 and respective outer latches 220 extending from the inner surface 200 of the upper plate 196, as shown in FIG. 7. As described in more detail herein, the inner latches 218 and the outer latches 220 correspond to a position of the inner hooks 154 and the outer hook 156 of the adapter 102 (FIG. 3). However, it should be appreciated that the upper plate 196 may include any number of inner latches 218 and outer latches 220 such as a single inner latch 218 and a single outer latch 220, or more than two inner latches 218 and more than two outer latches 220.

Referring still to FIG. 7, the pair of inner latches 218 are located closer to the trailing wall 192 than to the leading wall 202, and the pair of outer latches 220 are located closer to the leading wall 202 than to the trailing wall 192. In embodiments, as shown, the inner latches 218 and the outer latches 220 are provided entirely within the open interior 206 of the cap 104. In other embodiments, the inner latches 218 and the outer latches 220 extend out of the open interior 206 of the cap 104. The inner latches 218 and the outer latches 220 may be formed from a resilient material allowing the inner latches 218 and the outer latches 220 to bow outwardly upon a force being applied.

As described herein, the cap 104 is formed from any suitable material such as plastic, metal, rubber, synthetic polymer, thermoplastic polymer, a combination thereof, or the like. It should be appreciated that, in embodiments, the inner latches 218 and the outer latches 220 may be formed from one material having resilient properties, while other portions of the cap 104, such as the contact wall 106, the side wall 194, and the upper plate 196, are formed from a different material having less or no resilient properties as compared to the inner latches 218 and the outer latches 220. Accordingly, the inner latches 218 and the outer latches 220 may be formed from the same material or a different material forming the upper plate 196 to provide the particular resilient properties.

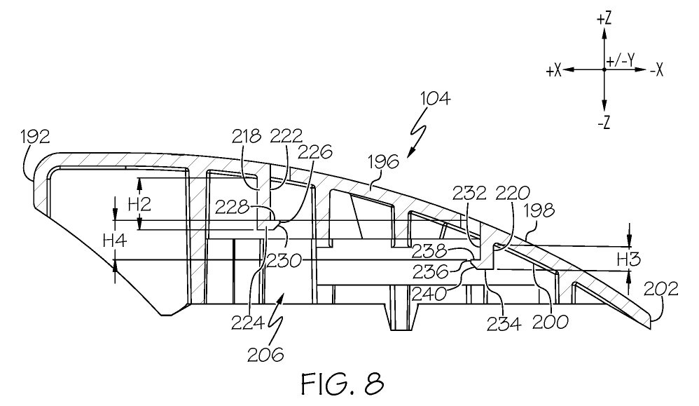

Referring now to FIG. 8, a cross-sectional view of the cap 104 is depicted to better illustrate the inner latches 218 and the outer latches 220. Each inner latch 218 includes a vertical inner latch portion 222 and a horizontal inner latch portion 224. The vertical inner latch portion 222 extends in the vertical direction from the inner surface 200 of the upper plate 196. The horizontal inner latch portion 224 extends from the vertical inner latch portion 222 in the lateral direction toward the leading wall 202 of the cap 104 and terminates at a distal end 226. The horizontal inner latch portion defines an inner shoulder 228 between the vertical inner latch portion 222 and the distal end 226. In embodiments, a lower surface 230 of the horizontal inner latch portion 224 is tapered.

Each outer latch 220 includes a vertical outer latch portion 232 and a horizontal outer latch portion 234. The vertical outer latch portion 232 extends in the vertical direction from the inner surface 200 of the upper plate 196. The horizontal outer latch portion 234 extends from the vertical outer latch portion 232 in the lateral direction toward the trailing wall 192 of the cap 104 and terminates at a distal end 236. The horizontal outer latch portion 234 defines an outer shoulder 238 between the vertical outer latch portion 232 and the distal end 236. In embodiments, a lower surface 240 of the horizontal outer latch portion 234 is tapered.

As shown in FIG. 8, the vertical inner latch portion 222 has a height H2 extending from the inner surface 200 of the upper plate 196. In embodiments, the height H2 is 10.414 mm +/- 20%. In embodiments, the height H2 is 10.414 mm +/- 15%. In embodiments, the height H2 is 10.414 mm +/- 10%. In embodiments, the height H2 is 10.414 mm +/- 5%.

The vertical outer latch portion 232 has a height H3 extending from the inner surface 200 of the upper plate 196. In embodiments, the height H3 is 5.766 mm +/- 20%. In embodiments, the height H3 is 5.766 mm +/- 15%. In embodiments, the height H3 is 5.766 mm +/- 10%. In embodiments, the height H3 is 5.766 mm +/- 5%.

The inner shoulder 228 of each inner latch 218 is located above the outer shoulder 238 of the outer latch 220 by a height H4 in the vertical direction due to the curved shape of the upper plate 196. Accordingly, the inner shoulders 228 and the outer shoulders 238 are located at different vertical planes. In other words, the inner shoulders 228 are vertically offset from the outer shoulders 238. In embodiments, the height H4 is 9.525 mm +/- 20%. In embodiments, the height H4 is 9.525 mm +/- 15%. In embodiments, the height H4 is 9.525 mm +/- 10%. In embodiments, the height H4 is 9.525 mm +/- 5%. Accordingly, as described in more detail herein, the height H4 is equal to the height H1 (FIG. 5) to ensure that the inner latches 218 engage the inner hooks 154, and the outer latches 220 engage the outer hook 156.

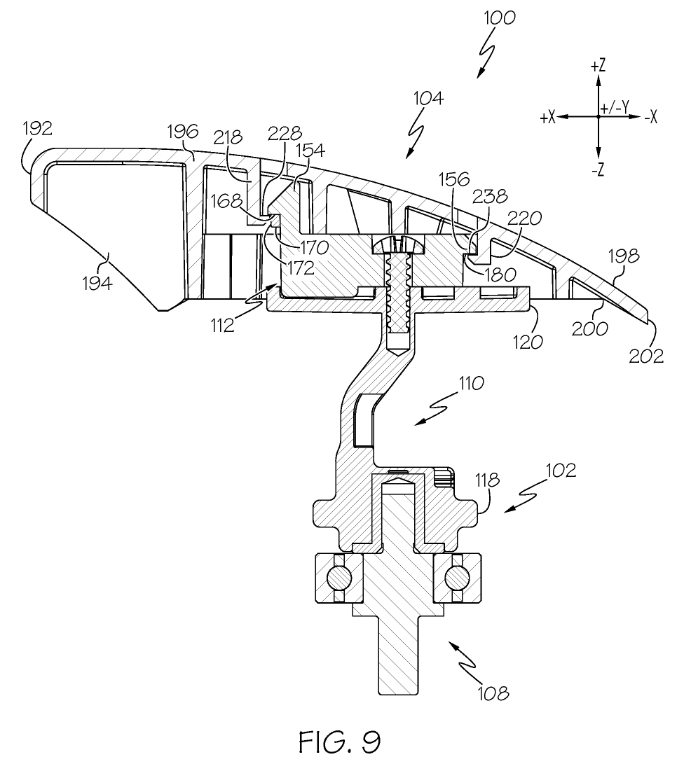

Referring now to FIG. 9, a cross-sectional view of the shoe assembly 100 is depicted illustrating the cap 104 mounted onto the adapter 102. Specifically, the inner latches 218 of the cap 104 are shown engaged with the inner hooks 154 of the adapter 102, and the outer latches 220 of the cap 104 are shown engaged with the outer hook 156 of the adapter 102.

The cap 104 may be installed onto the adapter 102 by positioning the cap 104 onto the adapter 102 while aligning the inner latches 218 and the outer latches 220 of the cap 104 with the inner hooks 154 and the outer hook 156, respectively, of the adapter 102. As noted above, the inner latches 218 and the outer latches 220 of the cap 104 are formed from a resilient material. Accordingly, a downward vertical force is then applied against the outer surface 198 of the upper plate 196 of the cap 104, which forces the inner latches 218 and the outer latches 220 of the cap 104 to bow outwardly in a lateral direction until the inner latches 218 and the outer latches 220 of the cap 104 engage the inner hooks 154 and the outer hook 156 of the adapter 102 and return to their original position.

As shown in FIG. 9, the inner shoulders 228 of the inner latches 218 of the cap 104 are positioned below the inner lip 168 of the inner hooks 154 of the adapter 102. Similarly, the outer shoulders 238 of the outer latches 220 of the cap 104 are positioned below the outer lip 180 of the outer hook 156 of the adapter 102. This results in the cap 104 being engaged with the adapter 102. In embodiments in which the protrusions 170 are provided under the inner lips 168 of each inner hook 154, the inner shoulder 228 of each inner latch 218 contacts the leading surface 172 of the protrusions 170 and limits an amount of extension of the inner shoulders 228 under the inner lips 168. Thus, the particular degree of deformation of the inner latches 218 to disengage the inner hooks 154 is less than that which would be required for the inner latches 218 to disengage the inner hooks 154 if the protrusions 170 were not provided. Accordingly, the particular force to be applied that results in the inner latches 218 of the cap 104 disengaging the inner hooks 154 of the adapter 102 may be tailored by a position and/or thickness of the protrusions 170. Additionally, it should be appreciated that the protrusions 170 create a tighter fit between the cap 104 and the adapter 102 by increasing a distance between the inner latches 218 and the outer latches 220, thus resulting in a greater clamping force by the cap 104 onto the adapter 102.

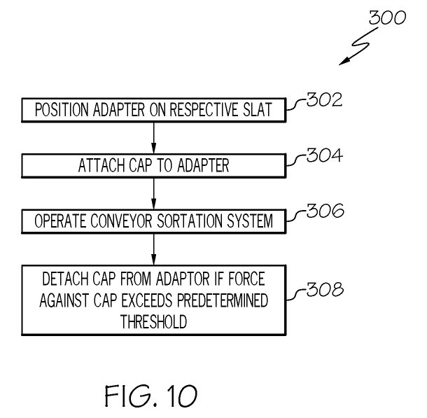

Referring now to FIG. 10, and with reference to FIGS. 1-9, operation of the conveyor sortation system 10 is described herein. At step 302, the adapter 102 of each shoe assembly 100 is positioned at an end portion of a respective slat 12, which defines a home position. Thereafter, at step 304, the cap 104 is positioned on a respective adapter 102. Accordingly, a plurality of shoe assemblies 100, each including an adapter 102 and a cap 104 removably coupled to the adapter 102, is provided on a respective slat 12.

At step 306, the conveyor sortation system 10 is operated by causing the slats 12 to move in the moving direction A. A location of each of the articles P is continually tracked by a monitoring system. When a particular article P is to be diverted off of the slats 12 on which the shoe assemblies 100 are provided, an actuator causes the shoe assemblies 100 to depart from the home position on the slats 12 and move along the divert guide path 14 in the lateral direction B in the +Y direction of the coordinate axis depicted in the drawings, which is perpendicular to the moving direction A of the slats 12. With the shoe assembly moving in the +Y direction, the contact wall 106 of the cap 104 contacts the article P and pushes the article P off of the slats 12 and onto a secondary conveyor 16.

As noted above, the inner latches 218 and the outer latches 220 of the cap 104 are designed to deform upon a force exceeding the predetermined threshold being applied to the contact wall 106 of the cap 104. The force exceeding the predetermined threshold may be a result of an article having a weight exceeding a predetermined threshold, which is intended to be moved by a plurality of adjacent shoe assemblies 100. At step 308, the deformation of the inner latches 218 and the outer latches 220 of the cap 104 causes the inner latches 218 and the outer latches 220 to disengage the inner hooks 154 and the outer hook 156 of the adapter 102, thereby resulting in the cap 104 being removed from the adapter 102.

From the above, it is to be appreciated that defined herein is a shoe assembly for diverting an article off a conveying surface. The shoe assembly includes an adapter and a cap. The adapter includes an inner hook and an outer hook. The cap includes an upper plate having a contact wall, and an inner latch and an outer latch extending from an inner surface of the upper plate. The inner latch is located at a different vertical plane than the outer latch. The inner latch of the cap engages the inner hook of the adapter and the outer latch of the cap engages the outer hook of the adapter. The inner latch and the outer latch deform to disengage the inner hook and the outer hook upon a force exceeding a predetermined threshold being imparted onto the contact wall of the cap.

By permitting the cap to be removed from the adapter, only the worn portion of the shoe assembly needs to be replaced, reducing maintenance costs and minimizing operational disruptions. Such a design extends the overall lifespan of the shoe assembly while maintaining consistent sorting performance. Additionally, permitting the cap to be removed allows for customization based on article characteristics, such as varying levels of hardness or friction to optimize diversion efficiency. An improved solution that balances durability, ease of maintenance, and adaptability significantly enhances the effectiveness of conveyor sorting systems.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A shoe assembly comprising:
an adapter including an inner hook and an outer hook; and
a cap including an upper plate having a contact wall, and an inner latch and an outer latch extending from an inner surface of the upper plate, the inner latch located at a different vertical plane than the outer latch,
wherein the inner latch of the cap engages the inner hook of the adapter and the outer latch of the cap engages the outer hook of the adapter,
wherein the inner latch and the outer latch deform to disengage the inner hook and the outer hook upon a force exceeding a predetermined threshold being imparted onto the contact wall of the cap.

2. The shoe assembly of claim 1, wherein:
the adapter includes a coupling having an upper surface, a lower surface opposite the upper surface, an inner surface, and an outer surface opposite the inner surface;
the inner hook extends from the upper surface and the inner surface; and
the outer hook extends from the upper surface and the outer surface.

3. The shoe assembly of claim 1, wherein an inner lip of the inner latch is provided at a first vertical position and an outer lip of the outer latch is provided at a second vertical position below the first vertical position.

4. The shoe assembly of claim 1, wherein the inner hook includes a pair of inner hooks.

5. The shoe assembly of claim 4, wherein:
each inner hook includes a vertical inner hook portion and a horizontal inner hook portion extending from the vertical inner hook portion, the vertical inner hook portion and the horizontal inner hook portion defining an inner lip; and
the outer hook includes a vertical outer hook portion and a horizontal outer hook portion extending from the vertical outer hook portion, the vertical outer hook portion and the horizontal outer hook portion defining an outer lip.

6. The shoe assembly of claim 5, further comprising a protrusion provided at the inner lip of each inner hook.

7. The shoe assembly of claim 6, wherein
the inner latch includes a pair of inner latches; and
the outer latch includes a pair of outer latches.

8. The shoe assembly of claim 7, wherein:
each inner latch includes a vertical inner latch portion and a horizontal inner latch portion extending from the vertical inner latch portion, the vertical inner latch portion and the horizontal inner latch portion defining an inner shoulder; and
each outer latch includes a vertical outer latch portion and a horizontal outer latch portion extending from the vertical outer latch portion, the vertical outer latch portion and the horizontal outer latch portion defining an outer shoulder.

9. The shoe assembly of claim 8, wherein the horizontal inner latch portion of each inner latch contacts the protrusion provided at the inner lip of each inner hook.

10. The shoe assembly of claim 8, wherein the inner shoulder of each inner latch is vertically offset from the outer shoulder of each outer latch.

11. A cap for a shoe assembly comprising:
an upper plate including an outer surface, an inner surface opposite the outer surface, a contact wall, a side wall opposite the contact wall, a leading wall, and a trailing wall opposite the leading wall defining an open interior;
an inner latch extending from the inner surface of the upper plate, the inner latch provided entirely within the open interior; and
an outer latch extending from the inner surface of the upper plate, the outer latch provided entirely within the open interior,
wherein the inner latch is provided closer to the trailing wall than the outer latch,
wherein the inner latch defines an inner shoulder provided at a first vertical position and the outer latch defines an outer shoulder provided at a second vertical position below the first vertical position.

12. The shoe assembly of claim 11, wherein
the inner latch includes a pair of inner latches; and
the outer latch includes a pair of outer latches.

13. The shoe assembly of claim 12, wherein:
each inner latch includes a vertical inner latch portion and a horizontal inner latch portion extending from the vertical inner latch portion, the vertical inner latch portion and the horizontal inner latch portion defining the inner shoulder; and
each outer latch includes a vertical outer latch portion and a horizontal outer latch portion extending from the vertical outer latch portion, the vertical outer latch portion and the horizontal outer latch portion defining the outer shoulder.

14. The shoe assembly of claim 13, wherein:
the horizontal inner latch portion of each inner latch extends from the vertical inner latch portion in a direction opposite the trailing wall; and
the horizontal outer latch portion of each outer latch extends from the vertical outer latch portion in a direction toward the trailing wall.

15. The shoe assembly of claim 11, wherein:
the inner latch includes a vertical inner latch portion and a horizontal inner latch portion extending from the vertical inner latch portion, the vertical inner latch portion and the horizontal inner latch portion defining an inner shoulder; and
the outer latch includes a vertical outer latch portion and a horizontal outer latch portion extending from the vertical outer latch portion, the vertical outer latch portion and the horizontal outer latch portion defining an outer shoulder.

16. A conveyor sortation system comprising:
a plurality of slats movable in a moving direction;
a secondary conveyor; and
a plurality of shoe assemblies, each shoe assembly of the plurality of shoe assemblies slidably engaged with a respective slat of the plurality of slats and configured to move along a divert guide path positioned below the plurality of slats, each shoe assembly of the plurality of shoe assemblies movable along the respective slat of the plurality of slats in a translating direction perpendicular to the moving direction, each shoe assembly comprising:
an adapter including an inner hook and an outer hook; and
a cap including an upper plate having a contact wall, and an inner latch and an outer latch extending from an inner surface of the upper plate, the inner latch located at a different vertical plane than the outer latch,
wherein the inner latch of the cap engages the inner hook of the adapter and the outer latch of the cap engages the outer hook of the adapter,
wherein the inner latch and the outer latch deform to disengage the inner hook and the outer hook upon a force exceeding a predetermined threshold being imparted onto the contact wall of the cap.

17. The conveyor sortation system of claim 16, wherein an inner lip of the inner hook is provided at a first vertical position and an outer lip of the outer hook is provided at a second vertical position below the first vertical position.

18. The conveyor sortation system of claim 16, wherein:
the inner hook includes a pair of inner hooks;
each inner hook includes a vertical inner hook portion and a horizontal inner hook portion extending from the vertical inner hook portion, the vertical inner hook portion and the horizontal inner hook portion defining an inner lip; and
the outer hook includes a vertical outer hook portion and a horizontal outer hook portion extending from the vertical outer hook portion, the vertical outer hook portion and the horizontal outer hook portion defining an outer lip.

19. The conveyor sortation system of claim 18, wherein
the inner latch includes a pair of inner latches;
the outer latch includes a pair of outer latches;
each inner latch includes a vertical inner latch portion and a horizontal inner latch portion extending from the vertical inner latch portion, the vertical inner latch portion and the horizontal inner latch portion defining an inner shoulder; and
each outer latch includes a vertical outer latch portion and a horizontal outer latch portion extending from the vertical outer latch portion, the vertical outer latch portion and the horizontal outer latch portion defining an outer shoulder.

20. The conveyor sortation system of claim 19, wherein the inner shoulder of each inner latch is vertically offset from the outer shoulder of each outer latch.
